(19) United States
(12) Patent Application Publication
(10) Pub. No.: US 2013/0012635 A1
(43) Pub. Date: Jan. 10, 2013

(54) CURED THERMOPLASTIC POLYMER FOR SHAPE MEMORY MATERIAL AND ARTICLES FORMED THEREFROM

(75) Inventors: Jiaxiang Ren, Houston, TX (US); David Peter Gerrard, Magnolia, TX (US); James Edward Goodson, Porter, TX (US); Lillian Guo, Houston, TX (US); Ping Duan, Cypress, TX (US)

(73) Assignee: BAKER HUGHES INCORPORATED, Houston, TX (US)

(21) Appl. No.: 13/179,251

(22) Filed: Jul. 8, 2011

(51) Int. Cl. C08G 75/14; C08L 77/00; C08L 61/18; C08K 3/30; C08K 3/34; C08K 5/5419; C08L 81/04; C08L 27/18; B82Y 30/00

(52) U.S. Cl. 524/267; 528/388; 524/609; 525/418; 525/537; 525/471; 525/534; 525/509; 524/606; 524/592; 525/189; 525/190; 525/185; 524/406; 524/445; 524/442; 977/742

(57) ABSTRACT

A thermoplastic material comprises the cure product of a thermoplastic polymer having a thermal decomposition temperature greater than or equal to about 200° C., the thermoplastic polymer being cured at a temperature of about 200° C. to about 400° C., for a total time of less than or equal to 200 hours. An article is formed from the thermoplastic material.

### BACKGROUND

Shape memory polymers (SMPs) are polymers which regain their original shape when heated above their glass transition temperature (Tg). Articles are formed from shape memory polymer by first heating above the glass transition temperature and then shaping the polymer, then subsequently fixing the shape by cooling to below the glass transition temperature. During deployment, the shaped article is heated above the glass transition temperature to allow recovery of the first molded shape.

Shape memory polymers are useful as materials of construction of elements for variety of downhole applications, particularly those which require the sealing off of a portion of a borehole, or constricting the spacing around an element, whether coaxial with the borehole or otherwise. While a number of different shape memory polymers are commercially available, SMPs having still greater thermal and chemical stability, as well as low cost, are desirable.

### SUMMARY

The above and other deficiencies of the prior art are overcome by, in an embodiment, a thermoplastic material comprising the cure product of a thermoplastic polymer having a thermal decomposition temperature greater than or equal to about 200° C., the thermoplastic polymer being cured at a temperature of about 200° C. to about 400° C., for a total time of less than or equal to 200 hours.

In another embodiment, a thermoplastic material comprises a cure product of polyphenylene sulfide having a thermal decomposition temperature greater than or equal to about 200° C., at a temperature of about 200° C. to about 400° C., cured for a time of less than or equal to about 200 hours.

In another embodiment, a thermoplastic material comprises the cure product of a thermoplastic polymer having a thermal decomposition temperature greater than or equal to about 200° C., a crosslinker, and optionally, an additive, the thermoplastic material being cured at a temperature of about 300 to about 400° C. to form a shape memory material.

In another embodiment, an article comprises a thermoplastic material comprising a cure product of a thermoplastic polymer having a thermal decomposition temperature greater than or equal to about 200° C., at a temperature of about 200° C. to about 400° C., cured for a time of less than or equal to about 200 hours.

### BRIEF DESCRIPTION OF THE DRAWINGS

Referring now to the drawings, wherein like elements are numbered alike in the several Figures:

FIG. 1 shows a differential scanning calorimetry (DSC) trace of an uncured and cured thermoplastic polymer; and

FIG. 2 is a dynamic mechanical analysis (DMA) plot of storage modulus versus temperature for a perfluoroelastomer, and an uncured and cured thermoplastic polymer.

### DETAILED DESCRIPTION OF THE INVENTION

A cured thermoplastic material as disclosed herein is prepared by thermal cure of a high-temperature thermoplastic polymer, in the presence of oxygen. The cured thermoplastic polymer has lower crystallinity and greater thermal stability than the thermoplastic material prior to curing, as well as improved shape memory properties such as more rapid recovery rate, and near-quantitative recovery of at least one pre-compression dimension.

Thermoplastic polymers curable by the method are not particularly limited provided they are high-temperature thermoplastics having balanced mechanical properties at high temperature, as well as good chemical resistance, and which are curable by an oxidative crosslinking mechanism.

High temperature thermoplastic polymers include those having a thermal stability, as evidenced by the thermal decomposition temperature, of greater than or equal to about 200° C., in another embodiment greater than or equal to about 250° C., and in another embodiment greater than or equal to about 300° C. The thermoplastic polymer is semi-crystalline or amorphous.

The thermoplastic polymer has a weight averaged molecular weight (Mw) of about 500 to about 100,000 g/mol, in another embodiment about 1,000 to about 75,000 g/mol, in another embodiment about 1,500 to about 50,000 g/mol, and in another embodiment about 2,000 to about 25,000 g/mol. In addition, the thermoplastic polymer has a melt flow, determined according to ASTM D 1283 at 316° C. under a 5 kg load, of greater than or equal to about 1 g/10 minutes, in another embodiment greater than or equal to about 10 g/10 minutes, and in another embodiment greater than about 50 g/10 minutes. Also, the thermoplastic polymer has a melt flow, determined according to ASTM D 1283 at 316° C. under a 5 kg load, of less than or equal to about 7,500 g/10 minutes, in another embodiment less than or equal to about 6,500 g/10 minutes, and in another embodiment less than or equal to about 5,500 g/10 minutes.

The thermoplastic polymer is linear, or is branched having a number of branches of greater than or equal to 1, in another embodiment greater than or equal to 2, and in another embodiment greater than or equal to 5 branching points per 1,000 carbon atoms along the polymer chain.

In an embodiment, the thermoplastics used herein are aromatic thermoplastics. Examples of thermoplastic polymers include polyamides, polyimides, polyetherimides, polyphenylene sulfides (PPS), polyaryletherketones (PAEK), polyetherether ketones (PEEK), polyethersulfones (PESU), polyphenylenesulfones (PPSU), polyphenylenesulfone ureas, or the like, or combinations comprising at least one of the foregoing. The thermoplastic polymers are linear or branched and are homopolymers or copolymers which include two or more of the foregoing exemplary polymers. Copolymers include random, alternating, graft, and block copolymers, the block copolymers having two or more blocks of different homopolymers, random copolymers, or alternating copolymers. The thermoplastic polymers can further be chemically modified to include, for example, functional groups such as halogen, alcohol, ether, ester, amide, etc. groups, or can be oxidized, hydrogenated, etc. Exemplary thermoplastics include polyphenylene sulfides with either a branched structure, such as those marketed under the tradename RYTON® by Chevron-Phillips, or a linear structure, such as those marketed under the tradename FORTRON® by Ticona. In an embodiment, the thermoplastic polymer is a polyphenylene sulfide. In a specific embodiment, the thermoplastic polymer is branched. The thermoplastic polymer is obtained and used in pellet or powder form.

In an embodiment, a thermoplastic material includes the cure product of a thermoplastic polymer having a thermal decomposition temperature greater than or equal to about 200° C., the thermoplastic polymer being cured at a temperature of about 200° C. to about 400° C., for a total time of less than or equal to 200 hours. In a specific embodiment, a thermoplastic material comprises a cure product of polyphenylene sulfide.

In another embodiment, a reactive elastomer or fluoropolymer is blended with the thermoplastic polymer before cure, and grafts to the thermoplastic polymer during cure to increase flexibility of the cured thermoplastic material. Exemplary useful reactive elastomers or fluoropolymers include nitrile-butyl rubber (NBR), hydrogenated nitrile-butyl rubber (HNBR), high fluorine content fluoroelastomers rubbers such as those in the FKM family and marketed under the tradename VITON® fluoroelastomers (available from FKM-Industries) and perfluoroelastomers such as FFKM (also available from FKM-Industries) and marketed under the tradename KALREZ® perfluoroelastomers (available from DuPont), and VECTOR® adhesives (available from Dexco LP), organopolysiloxanes such as functionalized or unfunctionalized polydimethylsiloxanes (PDMS), tetrafluoroethylene-propylene elastomeric copolymers such as those marketed under the tradename AFLAS® and marketed by Asahi Glass Co., ethylene-propylene-diene monomer (EPDM) rubbers, polyvinylalcohol (PVA), and the like, and combinations comprising at least one of the foregoing polymers.

The cured thermoplastic material is prepared by curing the thermoplastic polymer in the presence or absence of oxygen. Oxygen is included during curing as either pure oxygen or a mixture of gases. Where a mixture of gases is used, oxygen is mixed with any suitable inert gas such as, for example, nitrogen, helium, argon, carbon dioxide, or the like. In an embodiment, curing is carried out in air. Curing is carried out at ambient pressure, at a partial pressure lower than ambient, or at elevated pressures (>1 atmosphere).

Curing is carried out at a temperature of about 200 to about 400° C., in another embodiment about 250 to about 390° C., and in another embodiment about 300 to about 380° C. The curing time is for a total time of less than or equal to 200 hours. In an embodiment, where curing is in the presence of oxygen and/or a crosslinker, the curing time is for a total time of less than or equal to about 72 hours, in another embodiment less than or equal to about 48 hours, and in another embodiment less than or equal to about 24 hours. In an exemplary embodiment, curing is carried out at a temperature of about 350 to about 375° C., for a time of about 1 to about 20 hours, in another embodiment about 2 to about 6 hours, in air atmosphere at ambient pressure. In another exemplary embodiment, curing is carried out at a temperature of about 350 to about 375° C., for a time of about 1 to about 200 hours, in the absence of oxygen and at ambient pressure. It will be understood that where the curing temperature is close to or at about the thermal decomposition temperature, a combination of curing temperature and time is used such that during curing, the cured thermoplastic material exhibits less than or equal to 10% weight loss, in another embodiment less than 5% weight loss, and in another embodiment less than 1% weight loss.

The cured thermoplastic material is partially cured, or fully cured. Where the thermoplastic polymer is fully cured, the cured thermoplastic material is completely amorphous, without showing a melting temperature (Tₘ) transition as determined by, for example, differential scanning calorimetry (DSC), which corresponds to the melting of any of the crystalline regions of the semi-crystalline high temperature thermoplastic polymer. Alternatively, the cured thermoplastic material is partially cured, where analysis by DSC shows a reduction in the heat flow at the melting temperature (Tₘ) relative to that of the uncured thermoplastic polymer. Where the cured thermoplastic material is only partially cured, the cured thermoplastic material is semi-crystalline. As used herein, “semi-crystalline” means having a degree of crystallinity less than that of the uncured thermoplastic material. For example, where the thermoplastic material is about 30% crystalline (based on weight or volume) prior to curing, the cured thermoplastic material can after partial cure be about 10% crystalline. Partial cure can also be localized, based on the degree of exposure of the thermoplastic polymer to the oxygen atmosphere during curing. For example, where the thermoplastic polymer is provided as a pellet or particle, partial cure is obtained where the outermost, exposed portion (surface or layer) of a particle of the cured thermoplastic material is cured and has a low crystallinity (e.g., less than or equal to about 5% crystallinity, in another embodiment less than or equal to about 2% crystallinity, and in another embodiment less than or equal to about 1% crystallinity, based on volume), or is fully amorphous, while the interior of the pellet or particle is uncured. The portion cured, in this instance, corresponds to the diffusion depth of the oxygen into the pellet or particle during cure, and varies with variation in cure condition, i.e., temperature, pressure, oxygen concentration, and time.

Both the uncured thermoplastic polymer and the cured thermoplastic material each have a glass transition temperature T_{g} higher than ambient temperature. In an embodiment, the cured thermoplastic material has a T_{g}, corresponding to the amorphous regions, of greater than or equal to about 50° C., in another embodiment greater than or equal to about 60° C., in another embodiment greater than or equal to about 70° C., and in another embodiment greater than or equal to about 90° C.

In an embodiment, the cured thermoplastic material has a storage modulus of greater than or equal to about 1 megapascal, in another embodiment about 1.2 megapascals, and in another embodiment greater than or equal to about 1.5 megapascals, a temperature of greater than or equal to about 250° C., in another embodiment greater than or equal to about 275° C., and in another embodiment greater than or equal to about 300° C.

In another embodiment, the thermoplastic polymer is compounded with an additive prior to curing, and is then cured to form the thermoplastic material. Additive, as broadly used herein, includes any compound added to the thermoplastic to adjust the properties of the cured thermoplastic material, and includes for example a material such as a water-soluble additive useful for preparing a foam, or other additive such as a filler, crosslinker, or processing aid.

Fillers, as used herein, include reinforcing and non-reinforcing fillers. Reinforcing fillers include, for example, silica, glass fiber, carbon fiber, or carbon black, which can be added to the polymer matrix to increase strength. Non-reinforcing fillers such as polytetrafluoroethane (PTFE), molybdenum disulfide (MoS₂), or graphite can be added to the polymer matrix to increase the lubrication. Nanofillers are also useful, and are reinforcing or non-reinforcing. Nanofillers, such as carbon nanotubes, nanographenes, nanoclays, polyhedral oligomeric silsesquioxane (POSS), or the like, can be incorporated into the polymer matrix to increase the strength and elongation of the material. Nanofillers can further be functionalized to include grafts or functional groups to adjust properties such as solubility, surface charge, hydrophilicity, lipophilicity, and other properties. Combinations comprising at least one of the foregoing fillers can be used.

The crosslinker, where included, is for example elemental sulfur, silica, a quinone, a peroxy compound, a metal peroxide, a metal oxide, or a combination comprising at least one of the foregoing crosslinkers. Exemplary quinones include p-benzoquinone, tetramethylbenzoquinone, naphthoquinone, and the like. Peroxy compounds useful as crosslinkers include alkyl or aryl diperoxy compounds, and metal peroxides. Exemplary aryl diperoxy compounds include those based on dicumyl peroxide (DCP) and marketed by Arkema, Inc. under the tradename DI-CUP® including, DI-CUP® dialkyl peroxide, DI-CUP® 40C dialkyl peroxide (on calcium carbonate support), DI-CUP® 40K dialkyl peroxide, DI-CUP® 40KE dialkyl peroxide; and alkyl diperoxy compounds including 2,5-dimethyl-2,5-di(t-butylperoxy) hexane and marketed by Akzo-Nobel under the tradename TRIGONOX® 101. Exemplary metal peroxides include magnesium peroxide, calcium peroxide, zinc peroxide, or the like, or a combination comprising at least one of the foregoing. Metal oxides useful as crosslinkers include, for example, zinc oxide, magnesium oxide, titanium dioxide, or the like, or a combination comprising at least one of the foregoing.

A processing aid is a compound included to improve flow, moldability, and other properties of the cured thermoplastic material. Processing aids include, for example an oligomer, a wax, a resin, a fluorocarbon, or the like, or a combination comprising at least one of the foregoing. Exemplary processing aids include stearic acid and derivatives, low molecular weight polyethylene, and the like.

In preparing a mixture for a shape memory foam, a water-soluble additive is included. Exemplary water-soluble additives include salts such as sodium chloride, potassium chloride, potassium iodide, sodium sulfate, or other salt having a high solubility in water. Pore size, closed versus open cell porosity, and distribution are controlled in foams by the concentration and particle size of the water-soluble additive.

The cured thermoplastic material is pulverized prior to any compounding and/or molding. Pulverizing is done by any suitable method including use of a mortar and pestle, ball mill, grinder, or the like, so long as the particle size of the resultant pulverized curedthermoplastic material is suitable for adequate mixing. Any suitable particle size can be obtained by the pulverizing. In an embodiment, the thermoplastic material is pulverized into a particle size of less than or equal to about 10 mesh, in another embodiment less than or equal to about 20 mesh, and in another embodiment less than or equal to about 40 mesh. It will be understood that “less than” a mesh size refers to particle size defined by mesh number which is inversely correlated to particle size, i.e., the higher the mesh number, the smaller the particle size.

The shape memory material is prepared by, for example, curing the thermoplastic polymer in the presence of oxygen, compacting the cured thermoplastic polymer at a low processing temperature (for example, at less than or equal to about 200° C.), heating the cured thermoplastic polymer to a temperature greater than the glass transition temperature of the cured thermoplastic polymer, compression molding the cured thermoplastic polymer, and de-molding at a temperature greater than or equal to about the glass transition temperature of the cured thermoplastic polymer. Curing and heating are effected in the same or in separate steps.

Heating the cured thermoplastic polymer, generally as distinguished from curing, is similarly carried out at a temperature of about 200° C. to about 400° C., in another embodiment about 250 to about 400° C., and in another embodiment about 300° C. to about 400° C. The heating time is for greater than or equal to 2 hours, in another embodiment greater than or equal to about 5 hours, and in another embodiment about 5 to about 20 hours. Heating, in this instance, refers to heating the cured thermoplastic polymer above its glass transition temperature after cold molding, to retain the memory shape during the first molding step.

Alternatively, the shape memory material is prepared by compounding the thermoplastic polymer with a crosslinker and optionally, an additive, to form a mixture, compacting the mixture at room temperature, and heating the compression molded mixture in the presence of oxygen or without oxygen to a temperature greater than the glass transition temperature of the cured thermoplastic polymer. A heating time of less than or equal to about 200 hours is used to cure the thermoplastic polymer; when heating is done in the presence of oxygen, a shorter heating time of less than or equal to about 24 hours is used, and when heating is done in the absence of oxygen, a longer heating time less than or equal to 200 hours is used to cure the thermoplastic polymer. Compression molding of the cured thermoplastic polymer at above the glass transition temperature of the cured thermoplastic polymer, and de-molding at a temperature greater than or equal to about the glass transition temperature of the cured thermoplastic material, are then carried out. In this embodiment, heating is carried out at a temperature sufficient to cure the thermoplastic polymer, and hence curing and heating to above the glass transition temperature of the cured thermoplastic polymer are effected in the same step.

Where the shape memory material is a foam, the thermoplastic polymer is compounded with a water-soluble additive, prior to curing. The water-soluble additive is then removed after de-molding, for example by soaking and/or extracting the de-molded article with a suitable solvent (such as water, where a water-soluble additive is used), carried out in batch or continuous mode, at ambient or elevated temperatures and pressures.

The shape memory material, so prepared exhibits improved shape memory properties when compared with a comparable shape memory material but prepared with an uncured thermoplastic polymer. For example, a shape memory material, prepared using the cured thermoplastic material, and when compacted by 30% based on pre-compacting volume, has a recovery time during deployment of less than or equal to about 10 minutes, measured at about 10 psi at about 160° C. Also, a shape memory material prepared using the cured thermoplastic material, and when compacted by about 30% based on pre-compacting volume, recovers greater than or equal to about 90%, in another embodiment greater than or equal to about 93%, in another embodiment greater than or equal to about 95%, and in another embodiment greater than or equal to about 97%, of at least one dimension. It will be understood that shape recovery dimensions are determined upon deployment by heating the shape memory material at or above the glass transition temperature of the cured thermoplastic material.

Furthermore, the shape memory material shows high resistance when exposed to a chemical agent at a temperature greater than room temperature and pressure greater than atmospheric pressure. In this way, the shape memory material shows less reduction in properties such as, for example, glass transition temperature, than a comparable shape memory material prepared with an uncured thermoplastic polymer. In particular, the shape memory material, and the cured thermoplastic material, resist swelling and degradation of properties when exposed to chemical agents (e.g., water, brine, hydrocarbons, acids such as sulfuric acid, solvents such as toluene, etc.), even at elevated temperatures of up to 100° C., and at elevated pressures (greater than atmospheric pressure) or prolonged periods (e.g., of greater than one day).

The shape memory materials are useful for preparing elements for downhole applications. Exemplary elements include a packer element, a blow out preventer element, a submersible pump motor protector bag, a sensor protector, a sucker rod, an O-ring, a T-ring, a gasket, a sucker rod seal, a pump shaft seal, a tube seal, a valve seal, a seal for an electrical component, an insulator for an electrical component, a seal for a drilling motor, or a seal for a drilling bit, or other downhole elements.

The above embodiments are further demonstrated in the following examples, which are intended as illustrative only and are not intended to be limited thereto.

Curing of Polyphenylene sulfide. A bar sample of polyphenylene sulfide (PPS; RYTON® PR09-60, Chevron-Phillips) was cured at 680° F. (360° C.) in air for 2 hours, and evaluated by differential scanning calorimetry (DSC; TA Instruments; scan rate 10° C./min.).

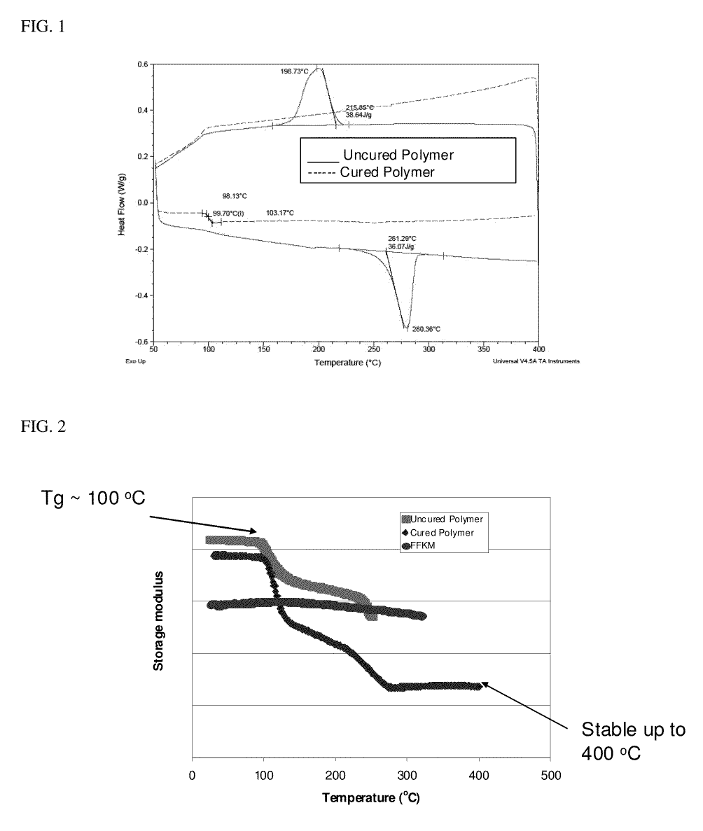

FIG. 1 shows the DSC trace (as a plot of Watts per gram versus temperature in ° C.). As seen in FIG. 1, an uncured sample of PPS exhibited a melting temperature (Tₘ) for the crystalline regions of about 280.4° C. (solid line), whereas the cured PPS exhibited only a glass transition temperature at about 99.7° C. Curing therefore renders the PPS amorphous as shown by the disappearance of the Tₘ transition.

FIG. 2 further shows a dynamic mechanical analysis (DMA) trace comparison for the cured PPS, the uncured PPS, and a perfluoroelastomer (FFKM K0090 from FKM Industries). As seen in FIG. 2, the storage modulus of cured PPS remained stable to 400° C., whereas the storage modulus of uncured PPS remained stable only to about 260° C., and that of the perfluoroelastomer remained stable only to about 320° C.

Shaped Memory of Cured PPS. Polyphenylene sulfide compacted pellets (PPS; RYTON® P-4, Chevron-Phillips) were pulverized to 20 or 40 mesh size and cured at 680° F. (360° C.) under air atmosphere for 2 hours. The cured PPS was packed into a button mold and compressed at room temperature, followed by heating to 680° F. (360° C.) under air atmosphere for 4 hours. The button mold was further compressed by 30% and heated to about the Tg of the cured PPS, and the molded cured PPS was then quenched in cold water after de-molding.

The button prior to compaction had a height of 5.84 mm, and after compaction and quench had a height of 4.74 mm (a compaction of 19%). Upon deployment by heating to 360° C., the deployed button had a height of 5.66 mm, for a height dimension recovery of about 97%. In addition, dynamic mechanical analysis (DMA; 10 psi pressure, 160° C.) of a similarly prepared pellet shows, upon deployment, dimensional recovery in less than 7 minutes.

While one or more embodiments have been shown and described, modifications and substitutions may be made thereto without departing from the spirit and scope of the invention. Accordingly, it is to be understood that the present invention has been described by way of illustrations and not limitation.

All ranges disclosed herein are inclusive of the endpoints, and the endpoints are independently combinable with each other. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A thermoplastic material comprising the cure product of:
a thermoplastic polymer having a thermal decomposition temperature greater than or equal to about 200° C., the thermoplastic polymer being cured at a temperature of about 200° C. to about 400° C., for a total time of less than or equal to 200 hours.

2. The thermoplastic material of claim 1, wherein the thermoplastic polymer is cured in the presence of oxygen.

3. The thermoplastic material of claim 1, wherein the cure product further comprises an additive combined with the thermoplastic polymer.

4. The thermoplastic material of claim 1, wherein the thermoplastic polymer is semi-crystalline or amorphous.

5. The thermoplastic material of claim 1, wherein the thermoplastic material is partially cured.

6. The thermoplastic material of claim 1, wherein the thermoplastic material is semi-crystalline or amorphous.

7. The thermoplastic material of claim 1, wherein the thermoplastic material has a glass transition temperature of greater than or equal to about 50° C.

8. The thermoplastic material of claim 1, wherein the thermoplastic material has a storage modulus of greater than or equal to about 1 megapascal measured at a temperature of greater than or equal to about 250° C.

9. The thermoplastic material of claim 1, wherein the thermoplastic material is polyphenylene sulfide.

10. An article comprising the thermoplastic material of claim 1.

11. The article of claim 10, wherein the article is a packer element, a blow out preventer element, a submersible pump motor protector bag, a sensor protector, a sucker rod, an O-ring, a T-ring, a gasket, a sucker rod seal, a pump shaft seal, a tube seal, a valve seal, a seal for an electrical component, an insulator for an electrical component, a seal for a drilling motor, or a seal for a drilling bit.

12. A thermoplastic material, comprising:
a cure product of polyphenylene sulfide having a thermal decomposition temperature greater than or equal to about 200° C., at a temperature of about 200° C. to about 400° C., cured for a time of less than or equal to about 200 hours.

13. The thermoplastic material of claim 12, wherein the thermoplastic material is cured in the presence of oxygen.

14. A thermoplastic material, comprising the cure product of:
a thermoplastic polymer having a thermal decomposition temperature greater than or equal to about 200° C.,
a crosslinker, and
optionally, an additive,
the thermoplastic material being cured at a temperature of about 300 to about 400° C. to form a shape memory material.

15. The thermoplastic material of claim 14, wherein the thermoplastic material is straight-chain or branched, and is a homopolymer or copolymer comprising a polyamide, a polyimide, a polyetherimide, a polyphenylene sulfide (PPS), a polyaryletherketone (PAEK), a polyetherether ketone (PEEK), a polyethersulfone (PESU), a polyphenylenesulfone (PPSU), a polyphenylenesulfone urea, or combinations comprising at least one of the foregoing.

16. The thermoplastic material of claim 14, wherein the crosslinker comprises sulfur, silica, a quinone, a peroxy compound, a metal peroxide, a metal oxide, or a combination comprising at least one of the foregoing crosslinkers.

17. The thermoplastic material of claim 14, wherein the additive is a reinforcing or non-reinforcing filler comprising silica, glass fiber, carbon fiber, carbon black, polytetrafluoroethane, MoS₂, graphite, carbon nanotube, nanographene, nanoclay, polyhedral oligomeric silsesquioxane, or a combination comprising at least one of the foregoing.

18. The thermoplastic material of claim 14, wherein the additive is a processing aid comprising an oligomer, a wax, a resin, a fluorocarbon, or a combination comprising at least one of the foregoing.

19. The thermoplastic material of claim 14, further comprising a reactive elastomer or fluoropolymer with the thermoplastic polymer before cure, wherein the reactive elastomer or fluoropolymer grafts to the thermoplastic polymer during cure to increase flexibility of the cured thermoplastic material.

20. An article comprising the thermoplastic material of claim 15.

21. An article, comprising:
a thermoplastic material, comprising:
a cure product of a thermoplastic polymer having a thermal decomposition temperature greater than or equal to about 200° C., at a temperature of about 200° C. to about 400° C., cured for a time of less than or equal to about 200 hours.

22. The article of claim 21, wherein the thermoplastic material is polyphenylene sulfide.
